(19) United States
(12) Patent Application Publication
(10) Pub. No.: US 2022/0412151 A1
(43) Pub. Date: Dec. 29, 2022

(54) ENGINEERED SILL SLOPE MEMBER

(71) Applicant: SPECD Building Products, LLC, Spanish Fork, UT (US)

(72) Inventor: Jeffrey Beckstead, Spanish Fork, UT (US)

(21) Appl. No.: 17/362,689

(22) Filed: Jun. 29, 2021

Related U.S. Application Data
(60) Provisional application No. 63/045,746, filed on Jun. 29, 2020.

(51) Int. Cl. E06B 1/70

(52) U.S. Cl. CPC E06B 1/702

(57) ABSTRACT

An engineered slope sill structure that include a first lateral edge next to the interior side of a building. The structure including a second lateral edge next to the exterior side of a building. The structure also includes a support surface extending from a first portion of the first lateral edge to a second portion of the second lateral edge where the support surface is designed to support a flow control device located in an opening formed by the building. The structure further includes a sloped surface located adjacent to the support surface and extending from a third portion of the first lateral edge to a fourth portion of the second lateral edge where the sloped surface has a first curved slope from the third portion of the first lateral edge to the fourth portion of the second lateral edge to direct moisture to the exterior of the building.

### BACKGROUND

In construction, structures (e.g., walls, ceilings, roofs, etc.) can form large openings for doors, windows, vents, heating ventilation, and air conditioning (HVAC), or the like and are used to allow flow through the structure. For instance, doors permit the transportation of people in and out of a house. In another instance, windows can be opened to allow ventilation or closed and sealed to prevent ventilation and to prevent undesired debris from entering (e.g., during inclement weather). These structures can include framing or other external substructures that provide support for a flow control device (e.g. doors, windows, or the like) that may be used to temporarily block or unblock the openings. These structures can include a sill that can be located at the base or bottom of the opening to help support the flow control device and to hold the flow control device in place.

Conventional sills are shelf-like, almost entirely flat surfaces that are often disposed on an upper surface of the bottom portion of framing that forms an opening (e.g. windows, doors, HVAC, or the like) of a structure of a building (e.g. a house). Conventionally (e.g., according to conventional framing procedures), parts or components are used to construct a sill onsite, which often leads to sills that are overly flat, sloped in undesired directions, and/or are inconsistently constructed at different parts of the building. Conventional sills or floors are made by using a flat material and putting a shim, or block of construction material under one side to angle the flat material along a makeshift slope that is dependent on the size of the shim. Multiple shims slope the opening of the flow control device. Shims often include random pieces of construction equipment (e.g. wood, plastic, or the like) that are not specifically cut with precision or for this purpose. Thus, a conventional sill, when installed on the framing, does not slope to the exterior of the building. Conventional sills often direct moisture to undesired locations (e.g. inside the building, inside the wall, inside the ceiling, etc.) or allow moisture to build up on the sill. A need exists for a pre-fabricated sill. A need exists for a sill that is not overly flat and may have relief features to direct water flow.

### BRIEF DESCRIPTION OF DRAWINGS

The examples described herein will be understood more fully from the detailed description given below and from the accompanying drawings, which, however, should not be taken to limit the application to the specific examples, but are for explanation and understanding only.

FIG. 1 illustrates a rear perspective view of an engineered sill slope member, according to certain embodiments.

FIG. 2 illustrates a rear-top view of an engineered sill slope member, according to certain embodiments.

FIG. 3 illustrates a top view of an engineered sill slope member, according to certain embodiments.

FIG. 4 illustrates a front view of an engineered sill slope member, according to certain embodiments.

FIG. 5 illustrates a back view of an engineered sill slope member, according to certain embodiments.

FIG. 6 illustrates a bottom view of an engineered sill slope member, according to certain embodiments.

FIG. 7 illustrates an engineered sill slope system including an engineered sill slope component on a framing member, according to certain embodiments.

FIG. 8 illustrates a length profile of an engineered sill slope member, according to certain embodiments.

FIG. 9 illustrates a length profile of an engineered sill slope member with a flashing extension, according to certain embodiments.

FIG. 10 illustrates a length profile of an engineered sill slope member, according to certain embodiments.

FIG. 11 illustrates a length profile of an engineered sill slope member, according to certain embodiments.

FIG. 12 illustrates a length profile of an engineered sill slope member, according to certain embodiments.

### SUMMARY OF THE INVENTION

Embodiments described herein are related to an engineered sill slope member. In some embodiments a sill slope member comprises a first lateral edge proximate an interior of a building; a second lateral edge comprising a curvilinear profile wherein the second lateral edge is distal the building and opposite the first lateral edge. wherein the profile of the; a first support surface extending from a first portion of the first lateral edge to a second portion of the second lateral edge, wherein the first support surface is configured to support a flow control device disposed in an opening formed by the building; and a sloped surface disposed adjacent to the first support surface and extending from a third portion of the first lateral edge to a fourth portion of the second lateral edge, wherein the sloped surface has a first curved slope from the third portion of the first lateral edge to the fourth portion of the second lateral edge to direct moisture in a first direction towards the exterior of the building.

In some embodiments the curvilinear edge comprises a scalloped profile with intermittent linear sections.

In some embodiments the slope sill member comprises a first lateral edge proximate an interior of a building; a second lateral edge comprising a curvilinear profile wherein the second lateral edge is distal the building and opposite the first lateral edge; a first support surface extending from a first portion of the first lateral edge to a second portion of the second lateral edge, wherein the first support surface is configured to support a flow control device disposed in an opening formed by the building; and a sloped surface disposed adjacent to the first support surface and extending from a third portion of the first lateral edge to a fourth portion of the second lateral edge, wherein the sloped surface has a first curved slope from the third portion of the first lateral edge to the fourth portion of the second lateral edge to direct moisture in a first direction towards the exterior of the building.

In some embodiments the an engineered sill slope member of further comprising a second support surface adjacent to the sloped surface, wherein the sloped surface is disposed between the first support surface and the second support surface, wherein the second support surface extends from a fifth portion of the first lateral edge to a sixth portion of the second lateral edge, wherein the sloped surface has a second curved slope forming a trough extending from the first support surface to a second support surface.

### DETAILED DESCRIPTION

Embodiments described herein are related to an engineered sill slope member.

The structures, systems, and methods disclosed herein provide an engineered sill slope member. An engineered sill slope member configured to be disposed on a surface of a structure (e.g., wall, framing) forming an opening. The engineered sill slope member has segments that provide frame support and segments that provide consistent moisture directing control. Along the length of the engineered sill slope member, the engineered sill slope member may include high support points or floor and low moisture drainage points, or curved sloped surfaces designed to direct moisture to the exterior of the structure. In some embodiments flashing may extend from the bottom outside edge of the sill slope member to direct water away from the building. In some embodiments, the engineered sill slope member is pre-engineered to direct moisture to the outside plane of a structure's Weather Resistive Barrier (WRB).

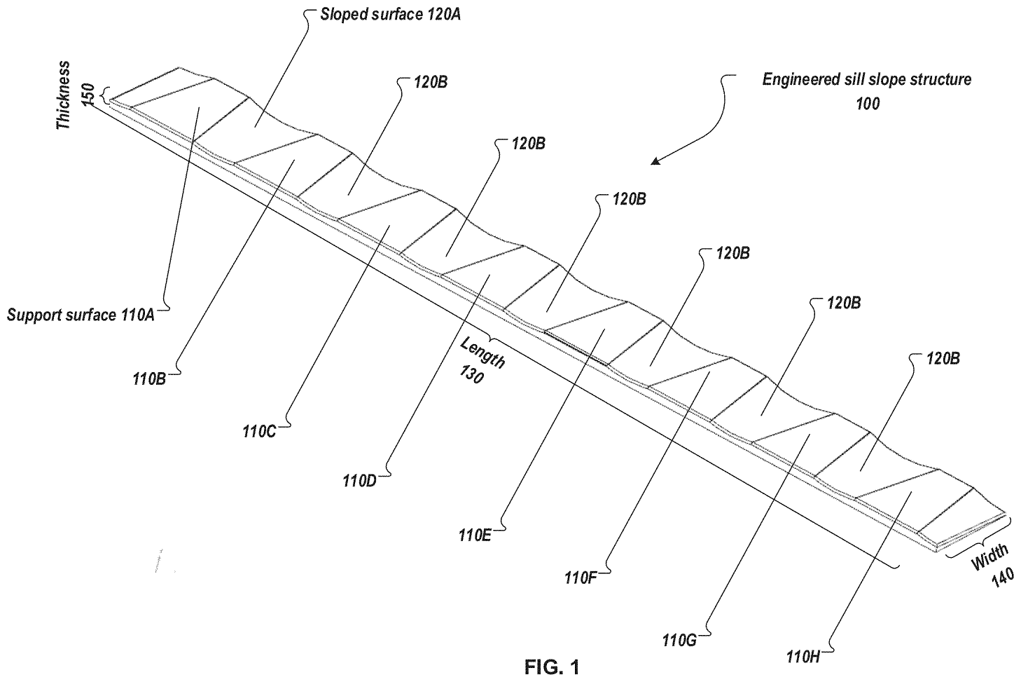

FIG. 1 illustrates a perspective view of an engineered sill slope member 100, according to certain embodiments. The engineered sill slope 100 may be designed to be inserted on an upper surface of a bottom portion of a frame forming an opening of a structure (e.g., wall, etc.). The ends of the engineered sill slope member 100 may be disposed against the sides of a frame of an opening. In some examples, the engineered sill slope member 100, when installed, is in direct contact with the sides of a window frame. The engineered sill slope 100 may include one or more support surfaces 110 and one or more sloped surfaces 120.

In some embodiments, the one or more support surfaces 110 are flat (e.g., disposed in a substantially horizontal plane) and are configured to be substantially parallel with a lower surface of the flow control device disposed above the engineered sill slope member 100. In some examples, a window is disposed on top of the engineered sill slope member 100 and one or more support surfaces 110 are flush with the bottom surface of the window.

In some embodiments, the engineered sill slope member 100 may have one support surface 110 such that the flow control device is fully supported by the one support surface 110. For example, the support surface 110 may be disposed in the middle of the upper surface of the bottom portion of the frame that forms the opening, such that a window is supported by the sides of the frame that forms the opening and the one support surface 110. In other embodiments, various numbers and lengths of support surfaces 110 may be disposed along the length of the engineered sill slope member 100 and may provide support for the flow control device.

The sloped surfaces 120 may include a curved surface with a high and a low point along the width 140 of the engineered sill slope 100. In some embodiments the edge of the sill sloped member is scalloped. In some embodiments the edge of the sill sloped member is a gapped scalloped with intermittent linear or flat sections interposed between the curved scalloped sections. In some embodiments, a lateral side of a sloped surface 120 of the engineered sill slope member 100 proximate the interior of a building (e.g., opposite the lateral side of the sloped surface 120 of the engineered sill slope member 100 proximate the exterior of the building) will be relatively higher and curve down to a relatively lower point proximate the exterior of the building such that moisture is directed out of the building.

In some embodiments, the sloped surfaces 120 may be disposed along only a part of the width 140 of the engineered sill slope member 100. In other embodiments, the sloped surfaces 120 may be disposed along the entirety of the width 140. In some embodiments, the sloped surfaces 120 may provide an air gap between the engineered sill slope member 100 and a flow control device disposed above the sill. This air gap may provide improved direction of moisture, specifically moisture that may have accumulated under the opening of the structure. In some embodiments, the air gap may be filled with construction material (e.g. insulation material).

In some embodiments, the engineered sill slope member 100 may have a length of 130 of about 6 to 12 feet. In some embodiments, the engineered sill slope member 100 has a width 140 of about 4 to 8 inches. In some embodiments, the engineered sill slope member 100 has a thickness 150 of about ⅛ to ¾ inches. In some embodiments, the engineered sill slope member 100 may be pre-cut to fit customary building opening sizes. For example, the length of the engineered sill slope member 100 may be predetermined prior to creation of the engineered sill slope member 100 so that the engineered sill slope member 100 is configured to fit an opening formed by a building for a 24 inch-wide window. In other embodiments, the engineered sill slope member 100 may be engineered and created as a long device and may be cut into custom-sized pieces that are configured to be disposed in custom-sized openings formed by buildings (e.g., the engineered sill slope member 100 includes multiple smaller engineered sill slope member that may be cut into custom sized pieces as needed) whether offsite or onsite.

In some embodiments, the engineered sill slope member 100 may be designed to be covered by material to form a WRB. For example, WRB membranes, tapes, sealants or liquid emulsions may be used to cover the engineered sill slope member 100, hold it in place, and prevent moisture from reaching the engineered sill slope member 100 or other parts of the building (e.g., interior of the building, the frame, the wall, the insulation, etc.). The engineered sill slope member 100 may be configured such that WRB materials, such as sheet, liquids, tapes, or the like, conform to the support surfaces 110 and slope surface 120 such that the WRB materials materially maintain the same shape and slope to provide support and control the direction of moisture, respectively. In some embodiments, the engineered sill slope member 100 may be incorporated or integrated into a WRB system.

In some embodiments the engineered sill slope member 100 may be comprised of a rigid, semi-rigid, or flexible material. The engineered sill slope member 100 may comprise combustible or non-combustible material.

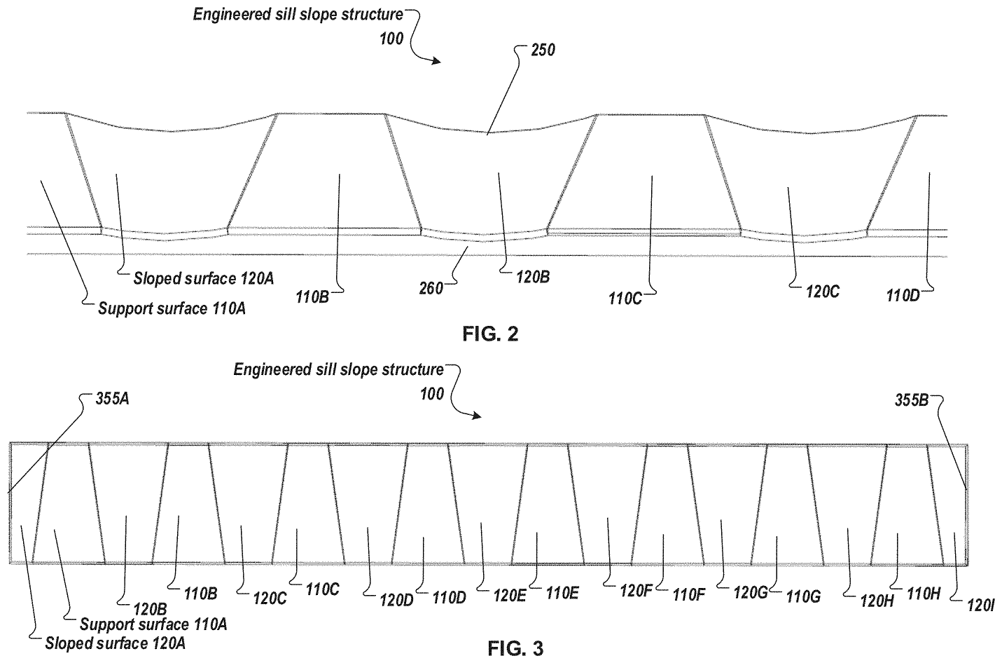

FIG. 2 illustrates a rear top view of an engineered sill slope member 100, according to certain embodiments and FIG. 3 illustrates a top view of an engineered sill slope member 100, according to certain embodiments. The engineered sill slope member 100 may include segments of support surfaces 110 and segments of sloped surfaces 120. In some embodiments, the distal ends 355 of the engineered sill slope member 100 may include any combination of support surfaces 110 and sloped surfaces 120. For example, both distal ends of the engineered sill slope member 100 may be support surfaces 110.

In some embodiments, the engineered sill slope member 100 may include an interior side 250 and an exterior side 260. The sloped surfaces 120 of the engineered sill slope member 100 may be configured to direct moisture from the interior side 250 to the exterior side 260. In some embodiments, the sloped surfaces 120 are longer along the interior side 250 than along the exterior side 260. For example, the sloped surfaces 120 are wider on the exterior side 250 to have a larger surface to gather moisture and narrower on the exterior side 260 to have greater control and precision in directing the moisture.

In some embodiments, the sloped surfaces 120 are uniform across the entire engineered sill slope member 100. In other embodiments, the sloped surfaces 120 can be custom machined to direct moisture in custom directions. In other embodiments, the slope surfaces may be different lengths across the engineered sill slope member 100. For example, different opening of a structure of different sizes may need different sized sloped surfaces 120 to account for moisture that each opening may be subjected to.

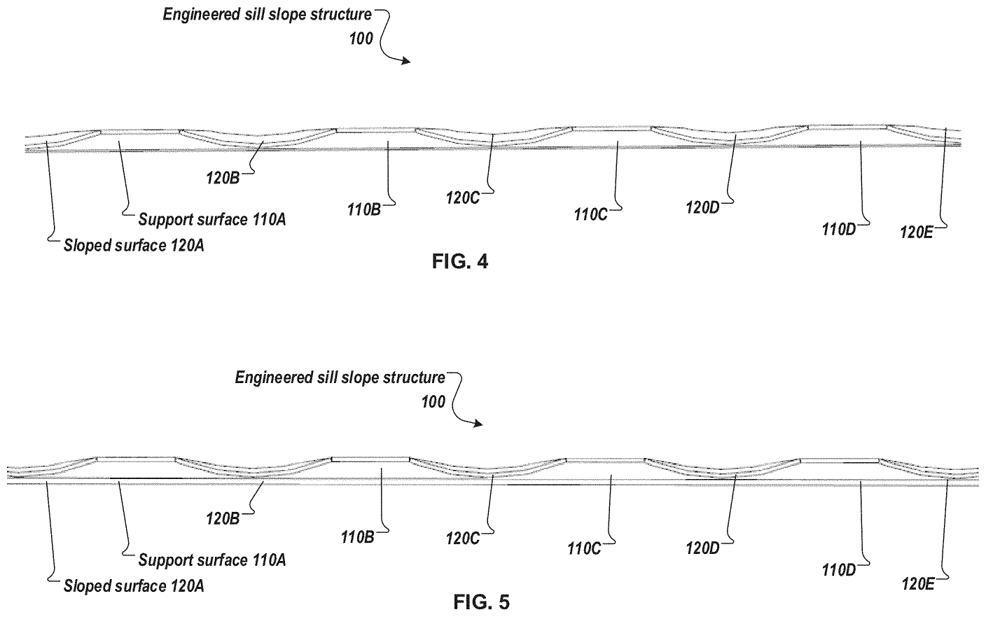

FIGS. 4 and 5 illustrate a front and back view, respectively, of an engineered sill slope member 100, according to certain embodiments. The engineered sill slope member 100 may comprise support surfaces 110 and sloped surfaces 120. In some embodiments, the sloped surfaces 120 may have a uniform positive slope directing moisture from one side of the engineered sill slope member 100 to another. In some embodiments, the sloped surfaces 120 have a linear slope to direct moisture. In some embodiments, the slope of the sloped surfaces 120 is curved and smooth. The sloped surfaces 120 may be designed to optimize breathability and moisture directing control through an air gap created by the sloped surfaces 120. In some embodiments the sloped surfaces 120 are higher on a side closer to the interior of a structure and lower on a side closer to an exterior of a structure.

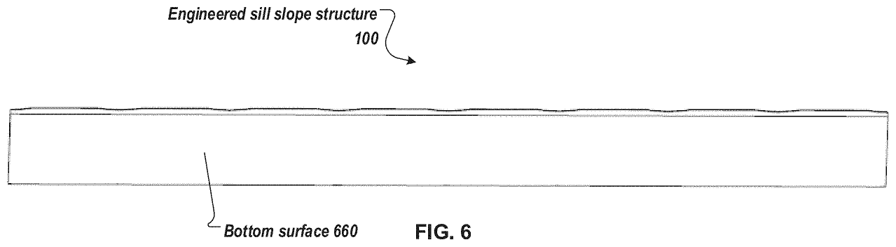

FIG. 6 illustrates a bottom view of an engineered sill slope member 100, according to certain embodiments. The engineered sill slope member 100 may include a bottom surface 660. In some embodiments, the bottom surface 660 is flat and smooth. In other embodiments, the bottom surface 660 is rigid or rough to prevent movement while installing. For example, the engineered sill slope member 100 may be covered with a WRB device (e.g. tape, sheet, adhesive) and the bottom surface may be rough or include an adhesive to hold the engineered sill slope member 100 in place while the WRB device is applied or installed.

In some embodiments, the bottom surface 660 may be configured to contact an upper surface of a bottom portion of a frame forming an opening of a building. The bottom surface 660 may comprise an adhesive, mechanical fastener, or other means to secure the engineered sill slope member 100 to the frame of the opening.

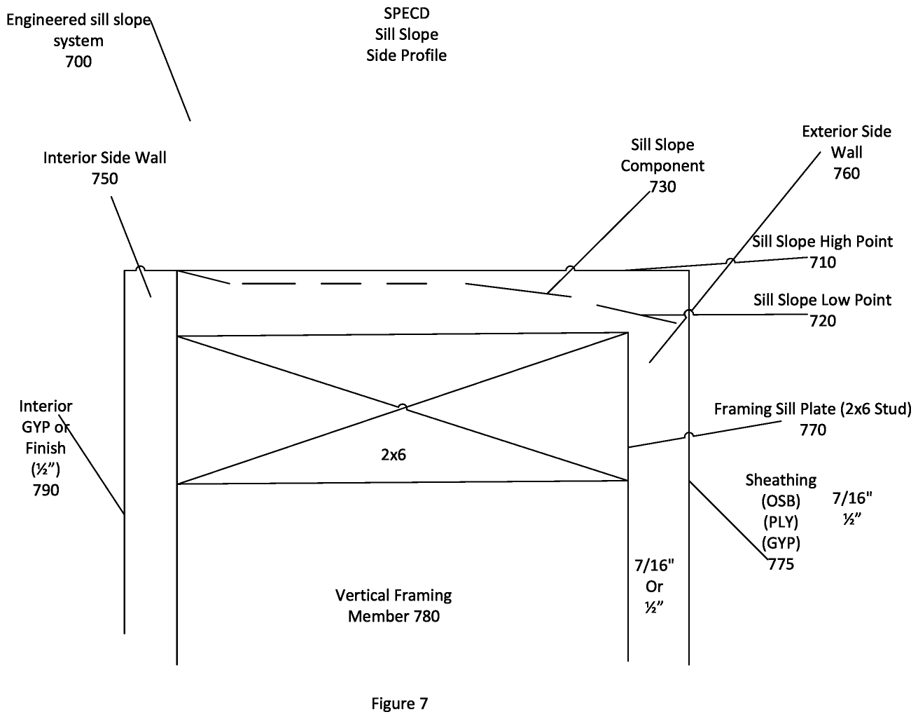

FIG. 7 illustrates a cross section view of an engineered sill slope system 700, according to certain embodiments. The engineered sill slope system 700 may include a sill slope component 730 (e.g., sloped surface of the engineered sill slope member 100) that comprises a high point 710 and a low point 720. The high point is 710 is configured to support a flow control device (e.g. door, window, or the like) in an opening formed by a structure (e.g. building, house, or the like). The combination of one or more high points 710 and low points 720 direct moisture from the interior side 750 of a wall of a structure to an exterior side 760 of a wall of a structure.

The sill slope component 730 may be disposed on a frame of an opening to a structure. For example, the sill slope component 730 may contact a vertical framing member 780. In some embodiments, the side of the sill slope component 730 proximate an interior side 750 of a wall may be disposed against a vertical support device 790. For example, the sill slope component 730 may be in direct contact with a gypsum board (e.g. drywall).

In some embodiments the sill slope component 730 may be disposed on a vertical framing member 780. In some embodiments, the sill slope component 730 may be adhered to the vertical framing member 780 by an adhesive. In other embodiments, the sill slope component 730 may be secured to the vertical framing member 780 through a securing device. For example, the sill slope component 730 may be secured to the vertical framing member 780 through fasteners (e.g. nails).

The engineered sill slope system 700 may include a framing sill plate 770 and sheathing 775. The sill slope component 730 may be disposed such that the edge of the side of the sill slope component 730 proximate an exterior side 760 of a wall may extend up to or past (e.g., be disposed on) a support structure (e.g. framing sill plate 770 and/or sheathing 775).

In some embodiments, the sill slope component 730 may be covered, secured, or used in conjunction WRB components, such as with WRB materials (e.g., WRB tape, WRB sealant, etc.). In some embodiments, the sill slope component 730 when used with WRB components retains its structure such that there still exists a high point 710 and a low point 720 to direct moisture from an interior side 750 of a wall to an exterior side 760 of a wall.

FIG. 8 illustrates length profiles 810, 820, and 830 of an engineered sill slope member 800, according to certain embodiments. The depicted length profiles 810, 820, and 830 may start at any distance from a vertical stud, and any combination of profile 810, 820, or 830 may be included on an engineered sill slope member. The engineered sill slope member 800 includes multiple embodiments showing the variations in sizes of high points 812, 822, 832 and low point points 814, 824, 834 as well as the variations of slope shape. In some embodiments the high points 812, 822, and 832 are to support a flow control device (e.g. window, door, or the like) and the low points 814, 824, and 834 are to direct moisture away from the interior of a structure.

In some embodiments (e.g., profile 810) the high points are curved (e.g., peaks), and the flow control device is supported at the peak of one or more high points 812. The low points 814 may also be curved (e.g., troughs) to direct moisture to the center of the low points 812 that will then be directed to the exterior of a structure. In some embodiments, the high points 812, 822, 832 may be as short as about ½ inch and as long as about 3 inches. In some embodiments, the low points 814, 824, 834 may be as short as about ½ inch and as long as about 4 inches.

In some embodiments (e.g. profile 820) the high points 824 are flat and the flow control device is supported over a flat surface at the high points 824.

In some embodiments, the engineered sill slope member 800 (see engineered sill slope member 100 of FIG. 1) lies flush with a vertical stud 850. The edge closest to the vertical stub may be supported by a sill plate 870 and a cripple stud 860. In some embodiments the vertical stub may be supported by a jack stud.

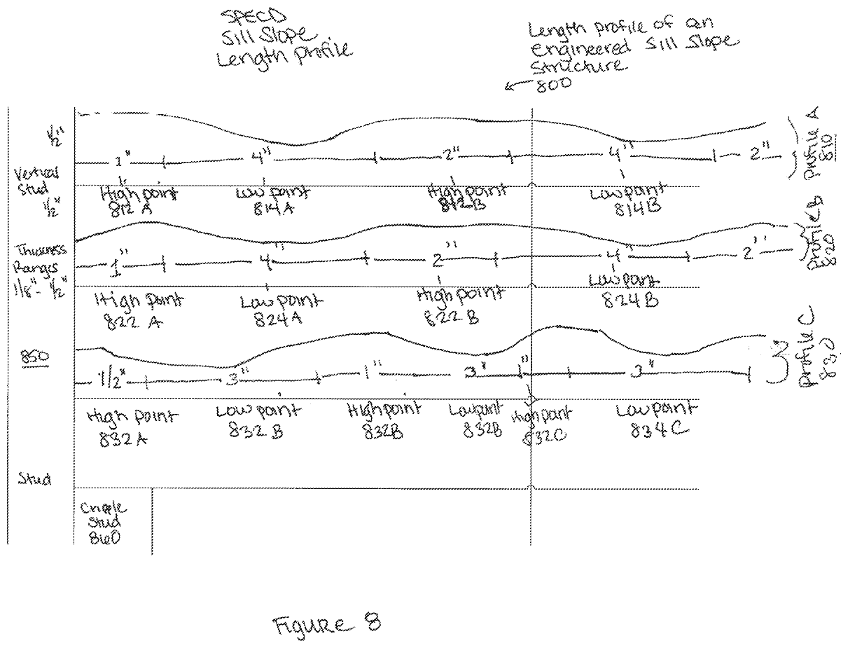

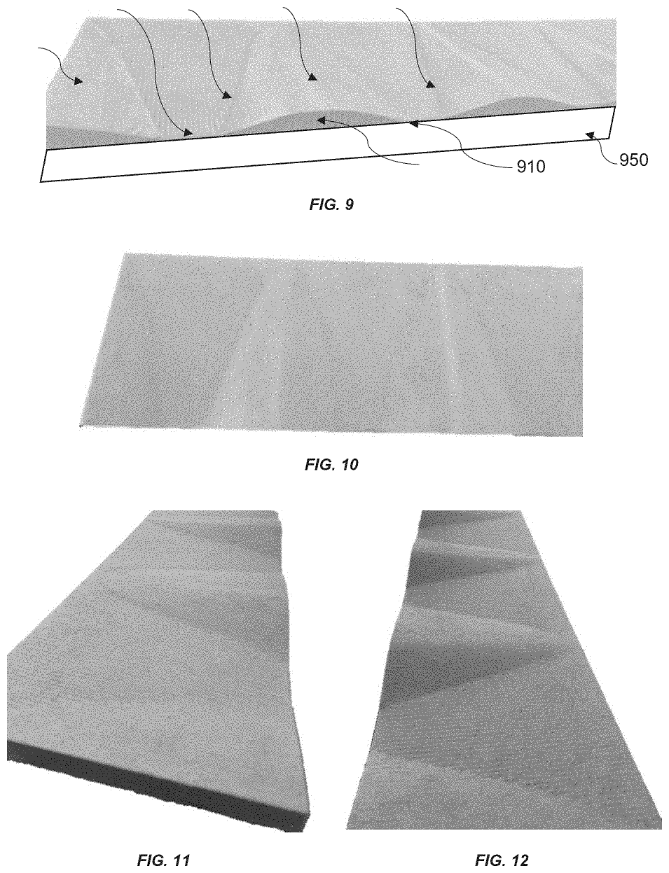

Some embodiments comprise a sill slope member as shown in FIGS. 9-12 wherein the bottom exterior edge 910 is substantially linear while the top exterior edge opposite the bottom exterior edge is sinusoidal, scalloped or curvilinear with a section of curved lines and a section of straight lines. In some embodiments the sill slope member is a composite with a body and a top surface. In some embodiments the sill slope member comprises a stamped member. In some embodiments the sill slope member is injection molded. In some embodiment the sill slope member is rotomolded. The manufacturing method used will impact the three-dimensional shape of the sill slope member, whether it is a stamped sheet, or has a body filling in below the top surface shape.

In some embodiments the sill slope member comprises a flashing member 950 extending below the bottom exterior edge of the sill slope member. In some embodiments the flashing comprises a flat sheet that is bent to the desired shape. In some embodiments the flashing extends distally from the bottom surface to the bottom exterior edge and is bent from the bottom exterior edge away from the sill slope member exterior edge.

Similar techniques and teachings of embodiments of the present disclosure can be applied to other types of components, devices, systems, and assemblies. In addition, the description herein provides examples, and the accompanying drawings show various examples for the purposes of illustration. However, these examples should not be construed in a limiting sense as they are merely intended to provide examples of embodiments of the present disclosure rather than to provide an exhaustive list of all possible implementations of embodiments of the present disclosure.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task.

Furthermore, use of the phrases ‘to,’ ‘capable of/to,’ and or ‘operable to,’ in one embodiment, refers to some apparatus, hardware, and/or element designed in such a way to enable use of the apparatus, hardware, and/or element in a specified manner. Note that use of to, capable to, or operable to, in one embodiment, refers to the latent state of an apparatus, hardware, and/or element, where the apparatus, hardware, and/or element is not operating but is designed in such a manner to enable use of an apparatus in a specified manner.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics can be combined in any suitable manner in one or more embodiments.

In the foregoing specification, a detailed description has been given with reference to specific exemplary embodiments. It will, however, be evident that various modifications and changes can be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but can refer to different and distinct embodiments, as well as potentially the same embodiment.

The words “example” or “exemplary” are used herein to mean serving as an example, instance or illustration. Any aspect or design described herein as “example′ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Also, the terms “first,” “second,” “third,” “fourth,” etc. as used herein are meant as labels to distinguish among different elements and can not necessarily have an ordinal meaning according to their numerical designation.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

What is claimed is:

1. A sill slope member comprising:
a first lateral edge proximate an interior of a building;
a second lateral edge comprising a curvilinear profile wherein the second lateral edge is distal the building and opposite the first lateral edge. wherein the profile of the;
a first support surface extending from a first portion of the first lateral edge to a second portion of the second lateral edge, wherein the first support surface is configured to support a flow control device disposed in an opening formed by the building; and
a sloped surface disposed adjacent to the first support surface and extending from a third portion of the first lateral edge to a fourth portion of the second lateral edge, wherein the sloped surface has a first curved slope from the third portion of the first lateral edge to the fourth portion of the second lateral edge to direct moisture in a first direction towards the exterior of the building.

2. The sill slope of member of claim 1 wherein the curvilinear edge comprises a scalloped profile with intermittent linear sections.

3. An engineered slope sill member comprising:
a first lateral edge proximate an interior of a building;
a second lateral edge comprising a curvilinear profile wherein the second lateral edge is distal the building and opposite the first lateral edge;
a first support surface extending from a first portion of the first lateral edge to a second portion of the second lateral edge, wherein the first support surface is configured to support a flow control device disposed in an opening formed by the building; and
a sloped surface disposed adjacent to the first support surface and extending from a third portion of the first lateral edge to a fourth portion of the second lateral edge, wherein the sloped surface has a first curved slope from the third portion of the first lateral edge to the fourth portion of the second lateral edge to direct moisture in a first direction towards the exterior of the building.

4. The engineered sill slope member of claim 3 further comprising a second support surface adjacent to the sloped surface, wherein the sloped surface is disposed between the first support surface and the second support surface, wherein the second support surface extends from a fifth portion of the first lateral edge to a sixth portion of the second lateral edge, wherein the sloped surface has a second curved slope forming a trough extending from the first support surface to a second support surface.
